(19) United States
(12) Patent Application Publication
(10) Pub. No.: US 2008/0085067 A1
(43) Pub. Date: Apr. 10, 2008

(54) Linear Guideway with Synchronously Operating Spacers

(76) Inventors: Hsin-Tsun Hsu, Taichung (TW); Hsing-Liang Chen, Taichung (TW)

Correspondence Address: Dr. BANGER SHIA, 102 Lindencrest Ct., Sugar Land, TX, 77479-5201, US

(21) Appl. No.: 11/538,980

(22) Filed: Oct. 5, 2006

(51) Int. Cl. F16C 29/06

(52) U.S. Cl. 384/45

(57) ABSTRACT

A linear guideway with synchronously operating spacers comprises a rail having a first rolling groove, a sliding block having a second rolling groove, a plurality of rolling elements disposed between the first and second rolling grooves, and a plurality of spacers. A receiving groove is formed in the second rolling groove and is located at the return portion of the sliding block for passage of the connecting portion of the spacers. The inner side of the receiving groove in the return portion has been deviated backward as compared to conventional structure, and the center of circle-arc of the receiving groove is deviated toward the sliding block.

### BACKGROUND OF THE INVENTION

1. Field of the Invention

The present invention relates to a linear guideway, and more particularly to a linear guideway whose spacers move synchronously, which prevents the interference of the connecting portion of the spacers with the radial portion of the receiving groove thereof, effectively reducing the friction force during the operation of the linear guideway while improving the operation stability.

2. Description of the Prior Art

Linear guideway is used more and more widely in modern industries. In addition to its high precision transmission performance, the linear guideway also has many other advantages, such as low friction loss, high ratio of energy conversion, low noise, high rigidity and wear-resistance. Therefore, it is self-evident that the linear guideway is very important to various industrial mechanisms. Normally, the linear guideway is provided at both ends of its sliding block with a return portion (it is usually defined on the end caps of the sliding block) for enabling the rolling elements between the rail and the sliding block to circulate endlessly. The return portion is the key to enable the rolling elements to circulate.

The known circulation modes are all emphasized on preventing the occurrence of friction between the components of the spacer chain when circulating through the return portion. As for the linear guideway with the spacer chain, there are four known methods for solving the problem of friction:

First, JP Pat. No. 2,607,993 discloses a linear guideway, as shown in FIG. 1, wherein the spacers 101 of the spacer chain 10 are designed to have different thickness along its radial direction, so as to form an arc surface for mating with the rolling elements A. When the spacer chain 10 and the rolling elements A move to the return portions at both ends of the sliding block, the spacers 101 and the rolling elements A will collide with each other, as a result, the linear guideway can't run smoothly (as shown in the drawing that the spacer chain 10 produces a non-smooth and non-round route).

Second, JP Pat. No. H 05-196036 discloses a linear guideway as shown in FIG. 2, to prevent the spacers 111 of the spacer chain 11 from impacting the inner surface of the return portions of the sliding block, the connecting portion 112 of the respective spacers 111 is designed to be deviated from the center of the spacers 111 and to be inclined toward the inner side of the return portions of the sliding block, and two sides of the spacers 111 are not located in the same level with respect to the center of the arc, so as to prevent the spacers 111 from impacting the inner side of the return portions when pushed by the rolling elements A. However, this spacer chain 11 has the problem of installation direction and position, the assembling staff must be very meticulous when assembling the spacer chain 11, and the spacer chain 11 must be assembled in the correct direction and position. Therefore, it is inconvenient and laborsome.

Third, with reference to FIG. 3, which shows a linear guideway disclosed by U.S. Pat. No. 6,070,479, to prevent the spacers 121 from impacting the inner side of the return portions, the two sides of each of the spacers 121 are designed to have different height, the side of the respective spacers 121 facing the inner side of the rolling groove of the sliding block is comparatively low. Therefore, this spacer chain 12 also has the problem of installation direction.

Fourth, with reference to FIG. 4, which shows a linear guideway disclosed by U.S. Pat. No. 6,533,458, the portion of the respective spacers 131 of the spacer chain 13 for contacting the rolling elements A within the return portion is designed to have equal thickness, and the curvature of the spacer chain 13 corresponding to the return portion is limited so as to reduce the impact between rolling elements A and the spacers 131 within the return portion and make the spacer chain move smoothly. However, the problem is that the spacers 131 will still impact the return portion when pushed by the rolling elements A, and will increase the friction drag.

The present invention has arisen to mitigate and/or obviate the afore-described disadvantages.

### SUMMARY OF THE INVENTION

The primary objective of the present invention is to provide an easily assembled linear guideway with synchronously operating spacers.

To obtain such an objective, the linear guideway with synchronously operating spacers in accordance with the present invention comprises a rail having a first rolling groove, a sliding block having a second rolling groove, a plurality of rolling elements disposed between the first and second rolling grooves, and a plurality of spacers. The outer side of the plurality of spacers with central through hole is connected together by a connecting portion. A receiving groove is formed in the second rolling groove and is located at the return portion of the sliding block for passage of the connecting portion of the spacers. The upper and lower portions of the respective spacers are symmetrically arranged, so it doesn't require installation direction. Therefore, the present invention can be effectively achieved the objective for simply assembling.

The secondary objective of the present invention is to provide a low friction and stable linear guideway with synchronously operating spacers.

To obtain such an objective, a receiving groove is formed in the second rolling groove and is located at the return portion of the sliding block for passage of the connecting portion of the spacers. The linear guideway is characterized in that the inner side of the receiving groove in the return portion has been deviated backward as compared to conventional structure, and the center of circular-arc of the receiving groove is deviated toward the sliding block. Such arrangements prevent the interference of the connecting portion of the spacers with the radial inner side of the receiving groove, effectively reducing the friction force during the operation of the linear guideway while improving the operation stability.

### BRIEF DESCRIPTION OF THE DRAWINGS

FIG. 1 is an illustrative view of showing a conventional linear guideway disclosed in JP Pat. No. 2,607,993;

FIG. 2 is an illustrative view of showing a conventional linear guideway disclosed in JP Pat. No. H 05-196036;

FIG. 3 is an illustrative view of showing a conventional linear guideway disclosed in U.S. Pat. No. 6,070,479;

FIG. 4 is an illustrative view of showing a conventional linear guideway disclosed in U.S. Pat. No. 6,533,458;

FIG. 5 is a longitudinal cross sectional view of a linear guideway in accordance with the present invention;

FIG. 6 is a horizontal cross sectional view of a linear guideway in accordance with the present invention;

FIG. 7 is an illustrative view of showing a return path in accordance with the present invention;

FIG. 8 is a cross sectional view of showing a return path in accordance with the present invention;

FIG. 9 is an illustrative view of showing the circulation path in accordance with the present invention;

FIG. 10 is an assembly view of showing the return portion in accordance with the present invention;

FIG. 11 is an illustrative view of showing the spacers in accordance with the present invention;

FIG. 12 is an assembly view of the spacers and the rolling elements in accordance with the present invention; and

FIG. 13 is an illustrative view in accordance with the present invention of showing that the spacers are being pushed by the rolling element.

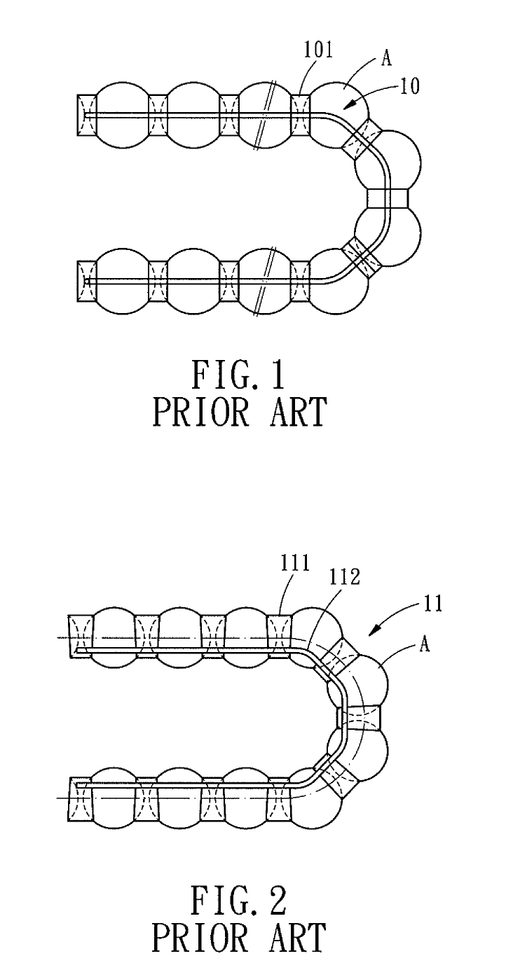

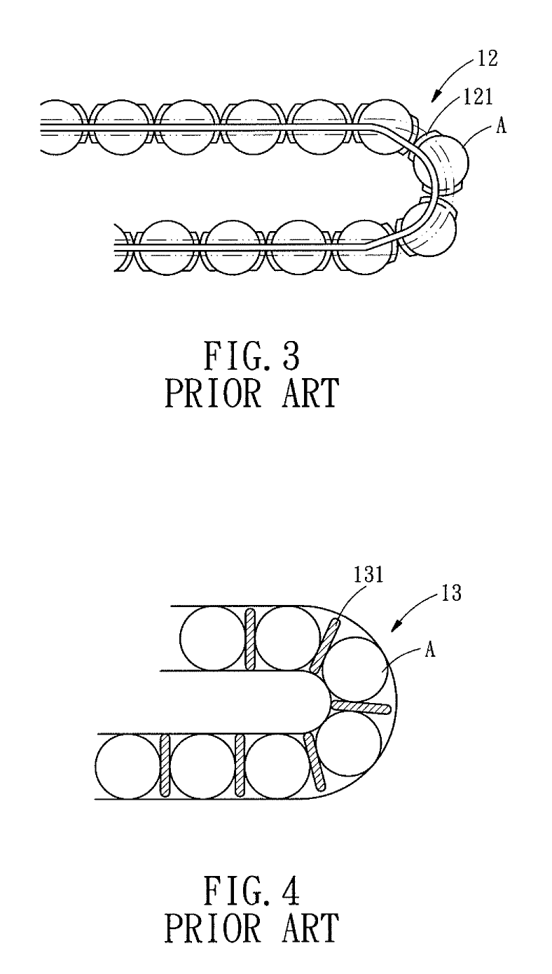

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

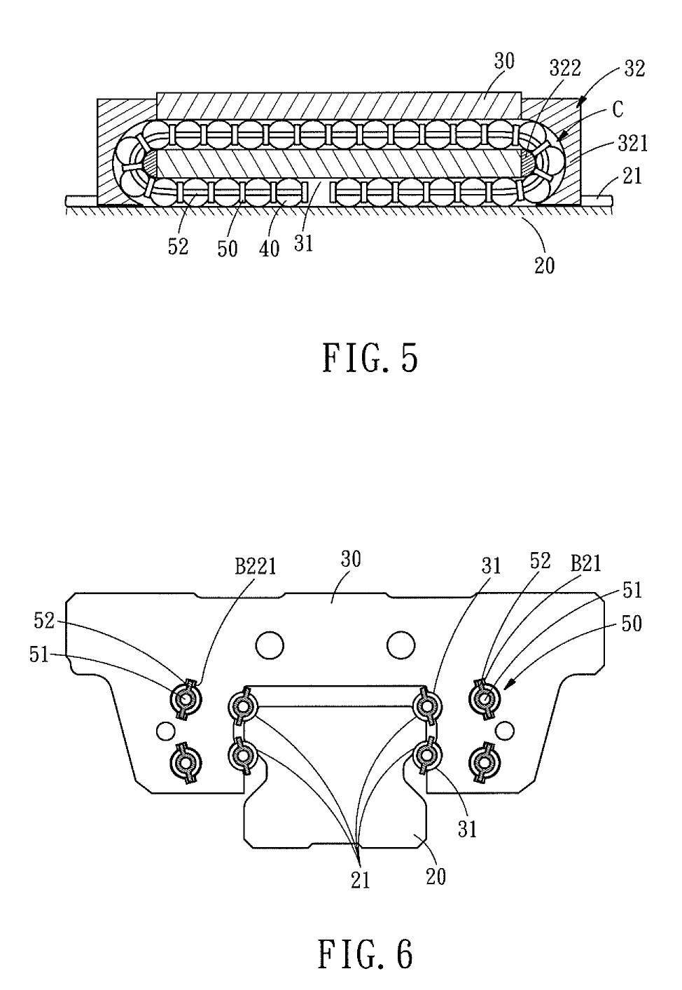

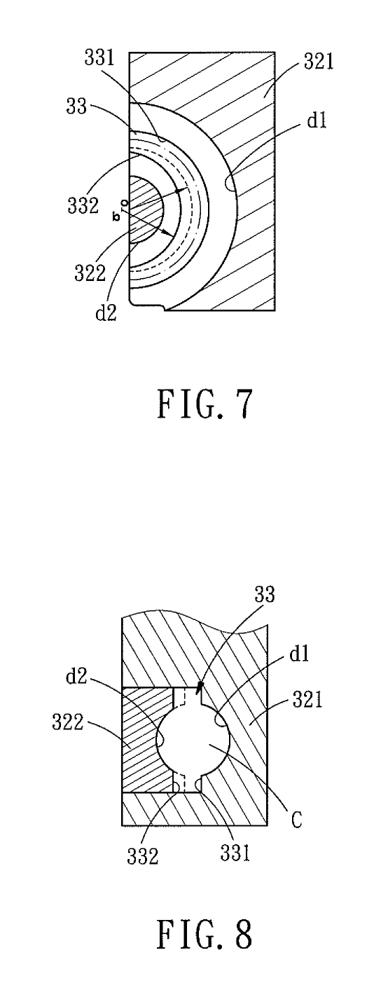

Referring to FIGS. 5-10, a linear guideway with synchronously operating spacers in accordance with a preferred embodiment of the present invention is shown and comprises: a rail 20, a sliding block 30, a plurality of rolling elements 40, and a plurality of spacers 50.

The rail 20 is provided along its length with first rolling grooves 21 for the rolling elements 40, and the rolling elements 40 here are steel balls, for example.

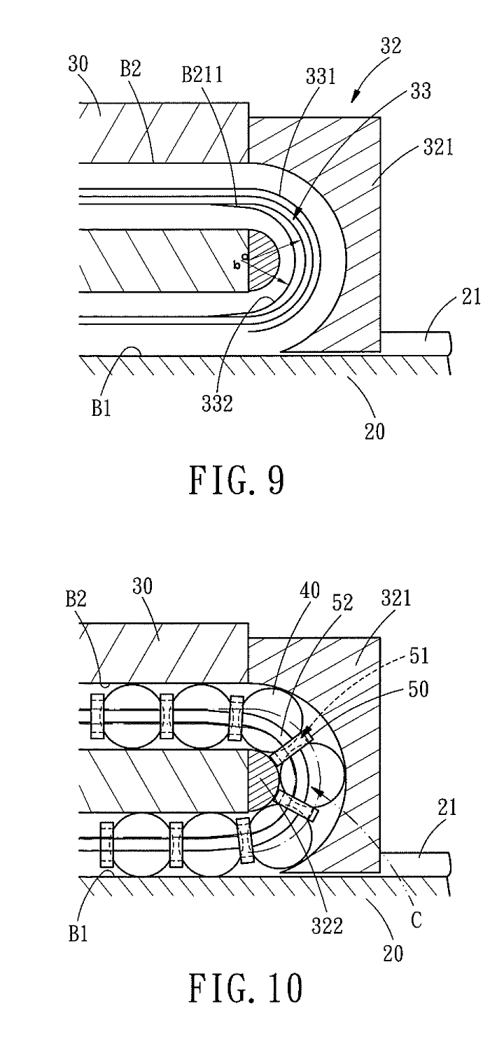

The sliding block 30 is moveably mounted on the rail 20 via the rolling elements 40. An end cap 32 is disposed at either end of the sliding block 30. The sliding block 30 is provided with second rolling grooves 31 for allowing the rolling elements 40 to circulate endlessly. (The second rolling groove 31 passes through the end caps 32.) The first and second rolling grooves 21, 31 form a circulation path, and the circulation path is functionally divided into loading path B1, non-loading path B2 and return path C. The loading path B1 is parallel to the non-loading path B2, and both of them are defined in the sliding block 30. The return path C is formed in the end cap 32 fixed at either end of the sliding block 30. The end cap 32 includes an outer guiding portion 321 and an inner guiding portion 322. The return path C includes a rolling path d1 in the outer guiding portion 321 and a rolling path d2 of the inner guiding portion 322. The non-loading path B2 of the sliding block 30 and the return path C at either end of the sliding block 30 are respectively defined with a receiving groove B21 and 33 for passage of the connecting portion 52 of the spacers 50. The outer guiding portion 321 of the receiving groove 33 of the return path C is provided for accommodation of the radial outer side 331 of the receiving groove 33, and the inner guiding portion 322 is provided for accommodation of the radial inner side 332 of the receiving groove 33. As compared with the conventional receiving groove, the receiving groove 33 in accordance with the present invention is modified to have an avoiding space (without reference No) defined in the radial inner side 332, and the amount of modification in the radial direction of the circular arc is unequal thickness, and the greatest amount of modification is located at the bottom of the semicircle arc, so that the center of circular-arc b of the radial inner side 332 of the modified receiving groove 33 is deviated from the original position O of the center of circular-arc and is close to the inner side of the sliding block, so that the modified groove 33 has different widths. When the spacer is bent to its utmost extent, the modified receiving groove will provide the largest avoiding space for the connecting portion of the spacer. Furthermore, a bevel surface B211 is formed in the receiving groove B21 of the non-loading path B2, so as to enable the receiving groove B21 and the receiving groove 33 in the end cap 32 to be connected more smoothly (as shown in FIG. 9).

The rolling elements 40 are located between the first rolling groove 21 of the rail 20 and the second rolling groove 31 of the sliding block 30 and circulate endlessly in the circulation path.

Each of the spacers 50 is disposed between two neighboring rolling elements 40 and is defined in its center with a through hole 51. The spacers 50 are linked together by the connecting portion 52 to create a chain, and the respective rolling elements 40 are surrounded by two spacers 50, thus preventing the rolling elements from falling off when the sliding block 30 is disengaged from the rail 20.

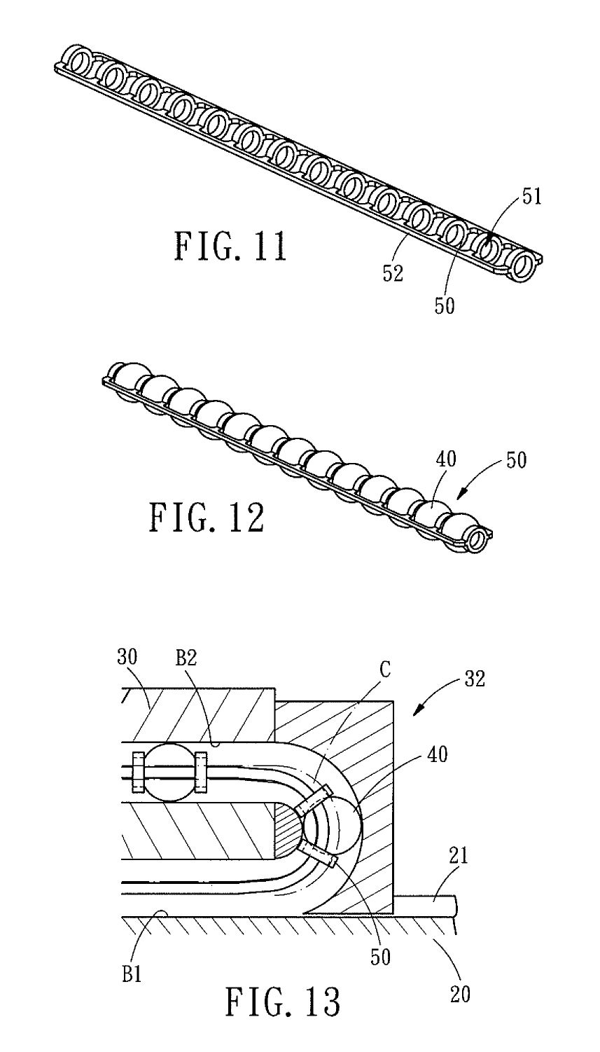

For a better understanding of the function and effect of the embodiment, reference should be made to FIGS. 11 and 12. In the conventional linear guideway, the spacers will be pushed toward the inner guiding portion by the rolling elements when moving through the return portion, so that the connecting portion will interfere with the radial inner side of the receiving groove, causing friction drag and adversely affecting the smooth operation of the linear guideway. The case of the present invention is different, when moving to the return path C, the spacers 50 will still be pushed toward inner guiding portion 322 by the rolling elements 40 (the steel balls as shown in the drawings). However, the inner guiding portion 322 has been modified to have an avoiding space which is large enough to prevent the connecting portion 52 from interfering with the receiving groove 33, thus ensuring a smooth circulation of the linear guideway (as shown in FIG. 13). It can be seen from the drawing that the avoid spacing of the modified inner guiding portion 322 of the receiving groove 33 is large enough to avoid the connecting portion 52, and the radial inner side 332 will not interfere with the connecting portion 52 and cause drag force.

On the other hand, the receiving grooves B21 and 33 enable the connecting portion 52 of the spacers 50 to be assembled without having to care about the installation direction in the circulation path. Therefore, the linear guideway can be assembled more easily.

The amount of modification in the radial direction of the circular arc is unequal thickness, and the greatest amount of modification is located at the bottom of the semicircle arc, so that the modified receiving groove 33 has different widths. When the spacer is bent to its utmost extent, the modified receiving groove will provide the largest avoiding space for the connecting portion of the spacer.

To summarize, the linear guideway with synchronously operating spacers in accordance with the present invention comprises a rail having a first rolling groove, a sliding block having a second rolling groove, a plurality of rolling elements disposed between the first and second rolling grooves, and a plurality of spacers. The outer side of the plurality of spacers with central through hole is connected together by a connecting portion. A receiving groove is formed in the second rolling groove and is located at the return portion of the sliding block for passage of the connecting portion of the spacers. The linear guideway is characterized in that the inner side of the receiving groove in the return portion has been deviated backward as compared to conventional structure, and the center of circle-arc of the receiving groove is deviated toward the sliding block. Such arrangements prevent the interference of the connecting portion of the spacers with the radial inner side of the receiving groove, effectively reducing the friction force during the operation of the linear guideway while improving the operation stability.

While we have shown and described various embodiments in accordance with the present invention, it is clear to those skilled in the art that further embodiments may be made without departing from the scope of the present invention.

What is claimed is:

1. A linear guideway with synchronously operating spacers comprising: a rail having a first rolling groove, a sliding block having a second rolling groove, a plurality of rolling elements disposed between the first and second rolling grooves, and a plurality of spacers, the spacers being connected by a connecting portion, a receiving groove formed in a return portion of the second rolling groove of the sliding block for accommodation of the connecting portion; characterized in that:
a center of circle-arc of an inner side of the receiving groove at the return portion of the second rolling groove is deviated toward the inner side of the sliding block, the inner side of the receiving groove shifts backward to create an avoiding space between the connecting portion and the inner side of the receiving groove.

2. The linear guideway with synchronously operating spacers as claimed in claim 1, wherein the first rolling groove is formed along a length of the rail, the sliding block is moveably mounted on the rail via the rolling elements, an end cap is disposed at either end of the sliding block, a return path is defined in the end cap, and the circle-arc of an inner side of the receiving groove at the return portion of the second rolling groove is deviated toward the sliding block.

3. The linear guideway with synchronously operating spacers as claimed in claim 1, wherein the first rolling groove of the rail and the second rolling groove of the sliding block form a circulation path for the rolling elements, and the circulation path is functionally divided into loading path, non-loading path and return path, the loading path is parallel to the non-loading path, and both of the loading path and the non-loading path are defined in the sliding block, the end cap includes an outer guiding portion and an inner guiding portion, the return path includes a rolling path in the outer guiding portion and a rolling path in the inner guiding portion, the outer guiding portion of the receiving groove of the return path is provided for accommodation of a radial outer side of the receiving groove, and the inner guiding portion of the receiving groove of the return path is provided for accommodation of a radial inner side of the receiving groove.

4. The linear guideway with synchronously operating spacers as claimed in claim 2, wherein the first rolling groove of the rail and the second rolling groove of the sliding block form a circulation path for the rolling elements, and the circulation path is functionally divided into loading path, non-loading path and return path, the loading path is parallel to the non-loading path, and both of the loading path and the non-loading path are defined in the sliding block, the end cap includes an outer guiding portion and an inner guiding portion, the return path includes a rolling path in the outer guiding portion and a rolling path in the inner guiding portion, the outer guiding portion of the receiving groove of the return path is provided for accommodation of a radial outer side of the receiving groove, and the inner guiding portion of the receiving groove of the return path is provided for accommodation of a radial inner side of the receiving groove.

5. The linear guideway as claimed in claim 3, wherein each of the non-loading path of the sliding block and the return path at either end of the sliding block is defined with a receiving groove for passage of the connecting portion of the spacers, a bevel surface is formed in the receiving groove of the non-loading path, so as to enable the receiving groove of the non-loading path and the receiving groove in the end cap to be connected together.

6. The linear guideway with synchronously operating spacers as claimed in claim 3, wherein the receiving groove in the return portion of the sliding block has unequal widths after modification.
